(19) United States
(12) Patent Application Publication
(10) Pub. No.: US 2004/0230184 A1
(43) Pub. Date: Nov. 18, 2004

(54) Multiple layer absorbent system

(76) Inventors: Kimberly H. Babusik, Wenonah, NJ (US); Elizabeth Miller, King of Prussia, PA (US); Bernadette M. Gibbs, Devon, PA (US)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/427,413

(22) Filed: May 1, 2003

(51) Int. Cl. G06F 15/16

(52) U.S. Cl. 604/904

(57) ABSTRACT

An absorbent article is provided that includes a fluid permeable top sheet and a transfer layer disposed adjacent the top sheet. A first layer is disposed adjacent the transfer layer. The first layer includes an absorbent composite having a first density. A second layer is disposed adjacent the first layer and includes an absorbent having a second density. The first density is greater than the second density such that a ratio of fluid retained by the first layer relative to fluid retained by the second layer is greater than 1.0. A fluid impermeable back sheet is disposed adjacent to the second layer. The ratio is desirably approximately 3.0. Alternatively, the absorbent article includes the first layer having an absorbent composite with a basis weight ranging from approximately 150 grams per square meter to 170 grams per square meter. The second layer includes an absorbent having a basis weight ranging from approximately 130 grams per square meter to 150 grams per square meter. The absorbent article may have a dry weight of less than approximately 5.20 grams and a fluid capacity of greater than or equal to 35.0 grams.

### BACKGROUND

1. Technical Field

The present disclosure generally relates to disposable absorbent articles, and more particularly, to disposable absorbent articles having an absorbent system including relative high density and low density layers.

2. Background of the Related Art

Absorbent articles such as, for example, disposable diapers, adult incontinent pads, sanitary napkins, pantiliners, incontinent garments, etc. are generally worn, in cooperation with garments and disposed against a body surface, etc., by infants or adult incontinent individuals. The absorbent article is employed to collect, absorb, etc. body fluid discharge, such as, for example, blood, menses, urine, aqueous body fluids, mucus, cellular debris, etc. For example, the absorbent article may be disposed between the legs of an individual adjacent a crotch area. The absorbent article is positioned with a garment and drawn into engagement with a body surface of the crotch area to collect fluid discharge.

As is known, absorbent articles typically include a fluid permeable coverstock for engaging the body surface, a fluid impermeable back sheet and an absorbent core supported therebetween. The back sheet serves as a moisture barrier to prevent fluid leakage to the garment. The absorbent core usually includes a liquid retention material that faces the body surface. The absorbent core can include loosely formed cellulosic fibers, such as wood pulp, for acquiring and storing fluid discharge.

The absorbent core absorbs fluid discharge and with regard to adult absorbent articles, such as, incontinent pads, are made fairly thick to handle large quantities of fluid, such as urine. The absorbent cores, however, can be unseemly due to their size and bulk. One of the disadvantages of these absorbent articles is the thick, diaper-like appearance which may be embarrassing to an adult wearer.

More recently, to overcome bulkiness, other absorbent articles, particularly feminine pads, sanitary napkins, pantiliners, incontinent garments, etc., are manufactured as long, narrow and relatively flat. These absorbent articles are designed to be worn close against the body surface and held in place by an undergarment.

Multiple core absorbent articles are known. Some of these articles, however, suffer from performance drawbacks including poor absorbency rates such as, for example, approximately 4.0 seconds and rewet values of approximately 2.0 grams. Attempts have been made to overcome these drawbacks by employing a top core layer, positioned closer to the body surface, that has a lower density and a bottom core layer that has a higher density. These attempts, however, may not desirably overcome the performance drawbacks. Further, the above designs can disadvantageously result in side leakage of the absorbent article.

It would therefore be desirable to overcome the disadvantages and drawbacks of the prior art by providing an absorbent article including a multiple layer absorbent system including relative high density and low density layers that facilitate improved absorbency performance and prevent leakage. It is contemplated that the absorbent article includes a high density absorbent composite adjacent a body surface and lower density absorbent disposed on an opposing side thereof. It is further contemplated that a transfer layer is disposed between the absorbent composite and the body surface. It would be desirable if the absorbent article and its constituent parts are easily and efficiently manufactured.

### SUMMARY

Accordingly, an absorbent article is disclosed which includes a multiple layer absorbent system including relative high density and low density layers that facilitate improved absorbency performance and prevent leakage. The absorbent article desirably includes a high density absorbent composite adjacent a body surface and a lower density absorbent disposed on an opposing side thereof. Most desirably, a transfer layer is disposed between the absorbent composite and the body surface. The absorbent article and its constituent parts are easily and efficiently manufactured.

Objects and advantages of the present disclosure are set forth in part herein and in part will be obvious therefrom, or may be learned by practice of the present disclosure which is realized and attained by the instrumentalities and combinations pointed out in the appended claims for the devices and methods of the present disclosure consisting of its constituent parts, constructions, arrangements, combinations, steps and improvements herein shown and described.

The absorbent article of the present disclosure, may include a combination of various materials, with various basis weights, densities, and material dimensions, in a product design that reduces leakage, improves absorbency rates and avoids high rewets.

In one embodiment, the absorbent article has a three-layer system including a loft layer, a high-density material layer and a low-density material layer. The loft layer includes a three dimensional apertured film positioned directly beneath a topsheet that allows fluid to quickly move away from an end user. The higher density layer includes airlaid and super absorbent material (SAP) mix that facilitates pulling and trapping fluid away from a top surface of the absorbent article and end user while dispersing the fluid in a longitudinal direction along the absorbent article. The low-density layer has airlaid material that traps fluid not absorbed by the high density layer, thus eliminating side leakage. It is contemplated that this configuration can retain more that 35 grams of fluid, have an absorbency rate lower than 3.0 seconds and a rewet value of less than 0.5 grams.

Pursuant to exemplary test results, as described herein, the higher density SAP/airlaid layer of the absorbent article has a higher fluid retention than the lower density airlaid layer. This configuration allows all the fluid to be retained with the top higher density layer, while the bottom lower density layer acts as a reservoir for the top layer to reduce side leakage. Advantageously, the configuration of the absorbent article of the present disclosure has a ratio of greater than 1:1 between the top higher density layer and the bottom lower density layer. It is envisioned that the design of the absorbent article achieves a fluid retention ratio of top higher density layer relative to the bottom lower density layer equivalent to 3:1. This design overcomes ratios of products in the prior art with fluid retention ratios of a top layer to a bottom layer, such as, for example 1:24, 1:19, 1:7 and 1:1.

It is envisioned that the total fluid consumption for the top absorbent layer of the absorbent article of the present disclosure can exceed 49.5% while the bottom absorbent layer may consume less than 50.6% of fluid. It is further envisioned that the total fluid retention of the top absorbent layer can be greater than 1320%, while the bottom absorbent layer retains less than 1180% of fluid, pursuant to test results, as described herein.

In another embodiment, the absorbent article includes a three core system that advantageously results in a dryer, more absorbent and faster fluid transfer article. The absorbent article may include a loft or acquisition/transfer layer having three-dimensioned apertured film. The acquisition/transfer layer may have a basis weight of 10-100 grams per square meter (gsm). Desirably, the acquisition/transfer layer may have a basis weight of 36.6 gsm. The acquisition/transfer layer may have a width of 20-90 millimeters (mm). Desirably, the width of the acquisition/transfer layer may be 40-45 mm. An SAP/airlaid layer can be included having a basis weight of 80-400 gsm and may have a width of 20-90 mm. Desirably, the SAP/airlaid layer has a basis weight of 150-170 gsm. Most desirably, the SAP/airlaid layer has a width of 50-60 mm. A double tissue may be attached to the SAP/airlaid layer. Alternatively, separate tissue paper may be altered thereto that is preferably colored.

A third airlaid layer having a basis weight of 50-400 gsm and a width of 20-90 mm may also be included. Desirably the third airlaid layer has a basis weight of 140-200 gsm. Most desirably, the third airlaid layer has a width of 65-70 mm. This configuration of the absorbent article results in improved performance including for example, a fluid retention capacity of over 35.0 grams, an absorbency rate of 3.0 seconds and a rewet value under 0.5 grams. Desirably, the overall basis weight of the absorbent article may be 100-800 gsm.

The absorbent core is fabricated from a dense material, which desirably has a basis weight of 180 gsm. This core configuration traps any fluid not absorbed by the SAP/airlaid layer. The SAP/airlaid is thin and dense. This design facilitates pulling and trapping fluid away from the top of the absorbent article and end user while dispersing the fluid along the pad. The apertured film transfer layer facilitates fluid flow through the depth of the absorbent article or in a Z-directional flow of fluid. This allows the fluid to quickly disperse (under 3 seconds) away from the end user while the SAP in the SAP/airlaid core begins to trap the fluid.

In one particular embodiment, in accordance with the principles of the present disclosure, an absorbent article is provided that includes a fluid permeable top sheet and a transfer layer disposed adjacent the top sheet. A first layer has a garment facing surface and a body facing surface disposed adjacent the transfer layer. The first layer includes an absorbent composite having a first density. A second layer is disposed adjacent the garment facing surface of the first layer and includes an absorbent having a second density. The first density is greater than the second density such that a ratio of fluid retained by the first layer relative to fluid retained by the second layer is greater than 1.0. A fluid impermeable back sheet is disposed adjacent to the second layer. The ratio is desirably approximately 3.0.

The transfer layer may include a three dimensional apertured film. The transfer layer may include a material having a basis weight of 10-100 gsm. The absorbent composite of the first layer can include an airlaid material and a super absorbent polymer material. It is contemplated that the absorbent composite may include a super absorbent fiber. The absorbent composite of the first layer may have a basis weight ranging from approximately 80-400 gsm. The absorbent of the second layer can include an airlaid material, a super absorbent polymer material and/or a super absorbent fiber.

The absorbent of the second layer may have a basis weight ranging from approximately 50-400 gsm. The first layer and the second layer may each define a longitudinal length and a width. The width of the second layer is equal to or greater than the width of the first layer. The absorbent article can have a dry weight of less than approximately 6.00 grams and a fluid capacity of 34.00-46.00 grams.

In an alternate embodiment, the absorbent article includes the first layer having a body facing surface disposed for engagement with the transfer layer and in fluid communication therewith. The first layer includes an absorbent composite having a basis weight ranging from approximately 150 gsm to 170 gsm. The body facing surface of the second layer is disposed for engagement with the garment facing surface of the first layer and in fluid communication therewith. The second layer includes an absorbent having a basis weight ranging from approximately 130 gsm to 150 gsm. The absorbent article may have a dry weight of less than approximately 5.20 grams and a fluid capacity of greater than or equal to 35.0 grams.

### BRIEF DESCRIPTION OF THE DRAWINGS

The objects and features of the present disclosure are set forth with particularity in the appended claims. The present disclosure, as to its organization and manner of operation, together with further objectives and advantages may be understood by reference to the following description, taken in connection with the accompanying drawings, in which:

FIG. 1 is a side perspective view of one particular embodiment of an absorbent article in accordance with the principals of the present disclosure;

FIG. 2 is a cross-sectional view of the absorbent article taken along lines 2-2 of FIG. 1; and

FIG. 3 is a top view of the absorbent article shown in FIG. 1.

### DETAILED DESCRIPTION OF EXEMPLARY EMBODIMENTS

The exemplary embodiments of the absorbent article and methods of use disclosed are discussed in terms of fluid absorbent articles, and more particularly, in terms of an absorbent article including a multiple layer absorbent system having relative high density and low density that facilitate improved absorbency performance and prevent leakage. It is contemplated that the absorbent article, in accordance with the principals of the present disclosure, includes a high density absorbent composite adjacent a body surface and a lower density absorbent disposed on an opposing side thereof. The presently disclosed absorbent article avoids premature leakage, overflow, etc., of fluid discharge, such as, for example, blood, menses, urine, aqueous body fluids, mucus, cellular debris, etc. It is contemplated that the absorbent article may be employed with disposable diapers, adult incontinent pads, feminine pads, sanitary napkins, pantiliners, incontinent garments, etc. It is further contemplated that the present disclosure can also be used with bedding and furniture underpads, wound dressings, etc.

In the discussion that follows, the term “body facing surface” refers to a portion of a structure that is oriented towards a body surface, and the “garment facing surface” refers to a portion of the structure that is oriented towards a garment and is typically opposing the body facing surface and may be referred to as such. As used herein, the term “body surface” refers to a portion of an individual's body that the absorbent article is disposed with for collecting, absorbing, etc. fluid discharge from the individual.

The following discussion includes a description of the absorbent article, followed by a description of the method of use therefor in accordance with the present disclosure. Reference will now be made in detail to the exemplary embodiments of the disclosure, which are illustrated in the accompanying figures.

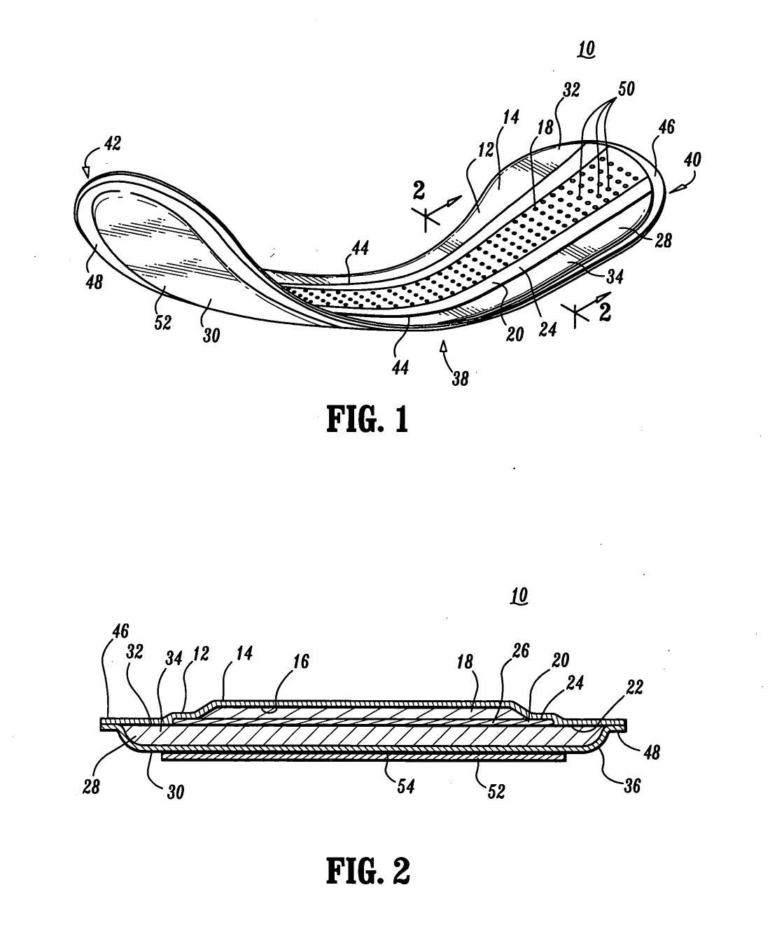

Turning now to the figures, wherein like components are designated by like reference numerals throughout the several views. Referring to FIGS. 1-3, there is illustrated an absorbent article 10, constructed in accordance with the principals of the present disclosure, including a fluid permeable top sheet such as, for example, coverstock 12 having a body facing surface 14 and a garment facing surface 16. A transfer layer, such as, for example, acquisition film layer 18 is disposed adjacent to coverstock 12.

A first layer, such as, for example, top absorbent layer 20 defines a longitudinal length a and width b. Top absorbent layer 20 has a garment facing surface 22 and a body facing surface 24 that engages acquisition film layer 18. Top absorbent layer 20 includes an absorbent composite 26 having a first density, as will be discussed. A second layer, such as, for example, bottom absorbent layer 28 defines a longitudinal length c and a width d. Bottom absorbent layer 28 has a garment facing surface 30 and a body facing surface 32 that engages garment facing surface 22 of top absorbent layer 20. Bottom absorbent layer 28 includes are absorbent 34 having a second density, as will be discussed.

The first density of absorbent composite 26 is greater than the second density of absorbent 34 such that a ratio of fluid retained by top absorbent layer 20 relative to fluid retained by bottom absorbent layer 28 is greater than 1.0. A fluid impermeable backsheet 36 is disposed adjacent bottom absorbent layer 28. It is contemplated that absorbent article 10 may include one or a plurality of absorbent layers, transfer/acquisition layers, top sheets and/or back sheets. It is further contemplated that the absorbent layers may be relatively disposed such as, for example, alternately layered, etc., in accordance with the principles of the present disclosure. It is envisioned that absorbent article 10 may include other absorbent pledgets, absorbent article structure, etc.

Absorbent article 10 is advantageously configured to reduce leakage improving absorbency performance and avoiding high rewet values. Most advantageously, absorbent article 10 conforms to the contour of a body surface and allows for quick dispersal of fluid discharge through its fluid management features, as discussed.

Pursuant to exemplary test results, as described herein, the higher density top absorbent layer 26 of absorbent article 10 has a higher fluid retention than the lower density of bottom absorbent layer 28 resulting in a higher fluid retention ratio. This configuration allows most, if not all, of fluid discharge to be retained by top absorbent layer 20, while bottom absorbent layer 28 acts as a reservoir for top absorbent layer 20 to reduce leakage. Advantageously, absorbent article has a fluid retention ratio of greater than 1.0 between top absorbent layer 20 and bottom absorbent layer 28. Desirably, the fluid retention ration of layer 20 to bottom absorbent layer 28 is 3:1.

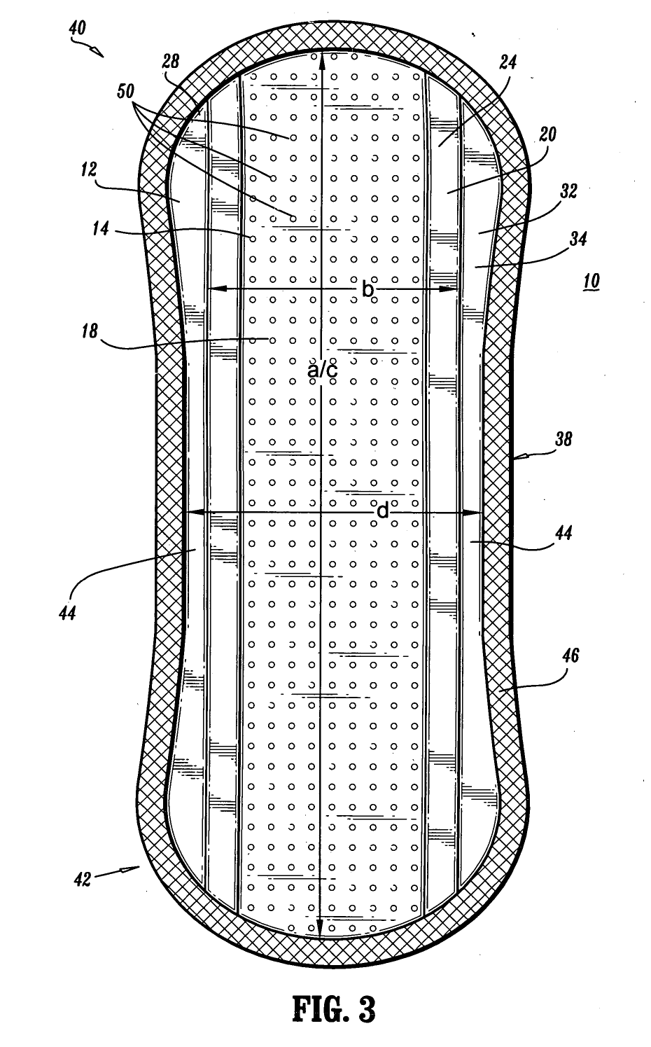

Top absorbent layer 20 and bottom absorbent layer 28 are disposed along a longitudinal length of absorbent article 10. As shown in FIG. 3, absorbent article 10 can be flattened to a planar configuration to define a longitudinal axis thereof. It is envisioned that top absorbent layer 20 and bottom absorbent layer 28 may be alternatively disposed relative to the longitudinal axis of absorbent article 10, such as, for example, transverse, offset, etc.

Absorbent article 10 fits and is contoured with a crotch area of an individual (not shown) to provide comfort during use. For example, absorbent article 10 and the components thereof have a central section 38 and outer arcuate ends 40, 42 to provide improved fit with the crotch area. It is envisioned that arcuate outer ends 40, 42 have a greater width than central section 38.

Absorbent article 10 is contemplated for fluid retention of discharged body fluids. More particularly, absorbent article 10 is envisioned to be a disposable absorbency device employing, among other things, multiple layers having relative high and low densities to improve absorbency and prevent leakage and overflow of fluids. The above advantages, among others, realized from the present disclosure are attained by absorbent article 10, which is flexibly conforming to a body surface. These features of the present disclosure advantageously facilitate fluid retention of discharged fluids and prevent consequent overflow.

Garment facing surface 16 of coverstock 12 is adhered to acquisition film layer 18 and body facing surface 14 and is configured to be worn against the body surface of an individual. Coverstock 12 preferably has a basis weight of 13 gsm or greater, although other basis weights are contemplated. Acquisition film layer 18 is configured to directly engage coverstock 12 for absorption and transmission of fluid discharge to portions of absorbent article 10, including top absorbent layer 20 and bottom absorbent layer 28. Coverstock 12 engages top absorbent layer 20 and bottom absorbent layer 28. It is contemplated that coverstock 12 may engage various portions of layers 20, 28, according to the particular absorbency application in accordance with the present disclosure.

In use, coverstock 12 is body fluid permeable, resilient, relatively non-absorbing and configured to direct fluid discharge to top absorbent layer 20 and bottom absorbent layer 28. Coverstock 12 is a spunbond polypropylene material. Consequently, coverstock 12 is easily permeated by fluid discharge. Further, coverstock 12 retains minimal or no fluid in its structure to provide a relatively dry surface adjacent the body surface. It is also designed for comfort and conformability to an individual. It is envisioned that coverstock 12 is fabricated from a bi-component fiber and through-air bonded. For example, the bi-component fiber may include a polypropylene or polyester inner core for strength and a polyethylene sheath for softness and the ability to thermally bond. It is contemplated that the coverstock material used is soft and at least partially lofty.

Coverstock 12 can be fabricated from a woven, non-woven, apertured film, natural or synthetic material easily penetrated by fluid discharge. Coverstock 12 is a single sheet of material having a width sufficient to overlay longitudinal sides 44 and arcuate outer ends 40, 42 of absorbent article 10, adjacent its longitudinal ends. Ends 40, 42 may have other geometric configurations. As shown in FIG. 3, coverstock 12 extends transversely about a body facing side of absorbent article 10. This configuration cooperates with fluid impermeable back sheet 36, which extends transversely about a garment facing side of absorbent article 10, to enclose the components thereof. It is envisioned that coverstock 12 and backsheet 36 may include multiple layers.

Coverstock 12 forms an outer edge 46 sealed with back sheet 36 to fully enclose the components of absorbent article 10. It is contemplated that coverstock 12 may be disposed over only a portion of absorbent article 10. Coverstock 12 may be fabricated from fibers or filaments of thermoplastic polymers, such as, for example, polyethylene, polypropylene, polyester, etc. Coverstock 12 may also be made from other materials which allow the ready passage of fluid through to top absorbent layer 20 and bottom absorbent layer 28, as is known to one skilled in the art. This includes apertured films, apertured nonwovens, rayon fibers, bi-component fibers, tissue, etc.

Acquisition film layer 18 is a three-dimensional apertured film that is adhered to garment facing surface of coverstock 12. Layer 18 includes apertures or cones 50 that facilitate fluid discharge flow directly to top absorbent layer 20. Thus, layer 18 manages, transports, accommodates and/or directs high volumes and high flow rates of fluid discharge to top absorbent layer 20. Layer 18 is configured to prevent fluid discharge from wetting through coverstock 12 when, for example, subjected to pressure, over-saturation (rewet). Acquisition film layer 18 has a basis weight of approximately 36.6 gsm. It is contemplated that layer 18 has a basis weight of 10-100 gsm.

Layer 18 has a narrower width than top absorbent layer 20 and bottom absorbent layer 28, and preferably has a width of 40-45 mm. It is contemplated that layer 18 may have a width of 20-90 mm. It is further contemplated that layer 18 may have a width substantially equivalent with layers 20, 28. Layer 18 may extend, for example, a length ranging from 180-250 mm. This configuration advantageously reduces rewet to promote skin wellness and reduce irritation. It is contemplated that layer 18 can be a through air bonded web, a bi-component non-woven web, cellulosic fibers, etc. Layer 18 may be adhesively secured in place by any suitable construction adhesive for absorbent core applications. It is envisioned that layer 18 is manufactured via die-cutting and registered although other fabrication methods known to one skilled in the art may be utilized.

Top absorbent layer 20 and bottom absorbent layer 28 are disposed longitudinally along absorbent article 10 to facilitate placement adjacent a body surface. The longitudinal configuration of absorbent article 10 permits placement between an individuals' thigh area and can be drawn up to cover the crotch area. At their outer ends, top absorbent layer 20 and bottom absorbent layer 28 have arcuate edges that are aligned with arcuate outer ends 40, 42 of absorbent article 10. These arcuate portions are also flexible for conforming to the body surface. It is envisioned that absorbent article 10 the components thereof, may be manufactured in various configurations and dimensions, such as, for example, rectangular, oval, hourglass, etc. The components of absorbent article 10 are soft and configured for comfort to an individual.

Absorbent composite 26 of top absorbent layer 20 is fabricated from a super absorbent polymer material and an airlaid material. Air laying is a process by which materials, such as, for example, fibrous non-woven webs may be fabricated, as is known to one skilled in the art. During an air laying fabrication process, bundles of small fibers are separated and entrained in an air supply and then deposited on to a forming screen. The randomly deposited fibers are bonded by, for example, hot air, spray adhesive, etc.

The configuration of top absorbent layer 20 forms a thin and flexible layer to facilitate desired deformity upon application of forces, such as, for example, body movement, elastic retraction, etc. Absorbent composite 26 has a higher density than absorbent 34 and is flexible, resilient, and has integrity in both dry and wet conditions. Absorbent composite 26 basis weight can preferably range from 150 to 170 gsm, depending on the size of absorbent article 10. It is contemplated that absorbent composite 26 may have a basis weight of 80-400 gsm. Absorbent article 10 may be fabricated in a variety of sizes and absorbency levels. Top absorbent layer 20 has a substantially rectangular configuration with rounded ends. However, other shapes are envisioned. Top absorbent layer 20 has a narrower width than bottom absorbent layer 28 and preferably is in the range of 50-60 mm. It is envisioned that layer 20 may have a width of 20-90 mm. Layer 20 may extend, for example, a length ranging from 180-250 mm.

Materials for absorbent composite 26 capable of absorbing and retaining fluid discharge may be used, such as, for example, a hydrophilic material such as cellulose fibers, wood pulp, regenerated cellulose, rayon, viscose, cotton fibers, or a blend of pulp and other fibers or foam with super absorbent polymer material. The bulk of absorbent composite 26 is reduced by adding SAP materials, having high liquid retention properties such as, for example, hydrocolloidal material, cross-linked acrylete polmers, etc., according to the requirements of a particular absorbency application. In addition, super absorbent fibers could be used as well. Super absorbent polymer particles can be permeated, desirably in granular form, through absorbent composite 26.

Body facing surface 24 of top absorbent layer 20 may include one or more acquisition layers which aid in the transfer of fluid discharge to absorbent composite 26. This layer may include a tissue, double tissue layer, etc. embossed or adhered thereto. Preferably, such a tissue layer is colored. Ink/laser jet printing on the tissue layer is contemplated. Top absorbent layer 20 may also be chemically or physically modified. It is contemplated that absorbent composite 26 may include such materials in combination with other materials both natural and synthetic.

Alternate designs are also envisioned whereby top absorbent layer 20 may have varying caliper zones, hydrophilic gradients, super absorbent gradients, low-density acquisition zones, multiple layers or structures, etc., according to the particular requirements of an absorbent article application. Absorbent composite 26 may define absorbency zones, such as, for example, a front, front-center, center, back-center, back, etc.

Absorbent 34 of bottom absorbent layer 28 is fabricated from an airlaid material. This forms a thin and flexible layer to facilitate desired deformity upon application of forces, such as, for example, body movement, elastic retraction, etc. Absorbent 34 has a lower density than absorbent composite 26 and is flexible, resilient, and has integrity in both dry and wet conditions. Absorbent 34 basis weight is preferably from 140 to 200 gsm, depending on the size of absorbent article 10. It is contemplated that layer 28 may have a width of 20-90 mm. Bottom absorbent layer 28 has a substantially rectangular configuration with rounded ends. However, other shapes are envisioned. Bottom absorbent layer 28 preferably has a width of 60-70 mm. It is contemplated that layer 28 may have a width of 20-90 mm. Layer 28 may extend, for example, a length ranging from 180-250 mm.

Materials for absorbent 34 capable of absorbing and retaining fluid discharge may be used, such as, for example, a hydrophilic material such as cellulose fibers, wood pulp, regenerated cellulose, rayon, viscose, cotton fibers, or a blend of pulp and other fibers. It is contemplated that super absorbent polymer particles may be used with bottom absorbent layer 28 according to the requirements of a particular absorbency application.

Body facing surface 32 of bottom absorbent layer 28 may include one or more acquisition layers which aid in the transfer of fluid discharge to absorbent 34. This layer may also include a tissue layer. Bottom absorbent layer 28 may also be chemically or physically modified. It is contemplated that absorbent 34 may include such materials in combination with other materials both natural and synthetic.

Alternate designs are also envisioned whereby bottom absorbent layer 28 may have varying caliper zones, hydrophilic gradients, super absorbent gradients, low-density acquisition zones, multiple layers or structures, etc., according to the particular requirements of an absorbent article application. Absorbent 34 may define absorbency zones, such as, for example, a front, front-center, center, back-center, back, etc.

Back sheet 36 is disposed adjacent to garment facing surface 30 of bottom absorbent layer 28 and extends to an outer edge 48 for sealing engagement with outer edge 46 of coverstock 12. Back sheet 36 generally faces away from the body surface and towards an undergarment worn by an individual. Back sheet 36 may permit passage of air and vapor from absorbent article 10 while preventing passage of fluid discharge therefrom. Alternatively, back sheet 36 may be completely fluid and vapor impervious. A garment facing side of back sheet 36 may have a cloth-like texture and be non-woven. Materials of fabrication for back sheet 36 can include fluid impermeable materials such as, for example, polylaminates, high basis weight SMS, SMMS with slot coat adhesive, polymeric films such as polyethylene, polypropylene, polyester, cellophane, etc. or a bi-component film such as ethel-vinyl-acetate and polyethelyne coextruded film. A treated material may also be used such as impregnated fluid repellent paper or a non-woven fabric. Other materials, however, may be used as is known to one skilled in the art.

Outer edges 46, 48 may be joined by pressure sensitive adhesives, heat sensitive adhesives, ultrasonics or by other known joining applications which prevent fluid discharge flow beyond outer edges 46, 48 and, consequently, from absorbent article 10.

The sealing engagement of outer edges 46, 48 extends continuously along the longitudinal length of absorbent article 10, adjacent longitudinal sides 44. It is contemplated, however, that the sealing engagement may be discontinuous, staggered, etc. It is envisioned that outer edges 46, 48 may extend outwardly various lengths or, alternatively, absorbent article 10 may not include edges 46, 48. Absorbent article 10 may include elastic members disposed with longitudinal sides 44, according to the requirements of a particular absorbent article application.

Back sheet 36 is a moisture barrier and includes a release strip 52 affixed thereto. Release strip 52 fully covers a positioning adhesive 54 and acts as protection to keep it from becoming exposed prior to use. Positioning adhesive 54 fixes absorbent article 10 to the outer crotch portion of an undergarment (not shown).

Release strip 52 includes silicone coating to allow easy removal from positioning adhesive 54 when absorbent article 10 is ready to be used. Positioning adhesive 54 may include one or more adhesive tracks, intermittently registered on the garment facing side of back sheet 36. A hot melt adhesive is used for positioning. It is envisioned that positioning adhesive 54 may include a pressure sensitive adhesive material such as, for example, a water based adhesive such as, acrylic adhesives, etc. It is further envisioned that rapid setting thermoplastic adhesives, two-sided adhesive tape, adhesives based on natural or synthetic rubbers, etc. may be used. It is contemplated that adhesive 54 may include alternative shapes such as lines, squares, circles, etc.

In use, absorbent article 10 is properly prepared and packaged for consumer application. Absorbent article 10 may be also be sterilized, if so desired. Release strip 52 is removed to expose positioning adhesive 54. Positioning adhesive 54 is brought into engaging contact with an undergarment of an individual (not shown) for attachment therewith. Absorbent article 10, with the undergarment, is disposed between the thighs of the individual. Ends 40, 42 of absorbent article 10 are oriented towards the front and the rear of the individual and directly below the crotch area.

Layer 18 absorbs and directly transmits fluid discharge to absorbent composite 26 of top absorbent layer 20. Top absorbent layer 20 retains substantially all of the fluid discharge. Any fluid discharge not retained by top absorbent layer 20 runs-off or flows to absorbent 34 of bottom absorbent layer 28. Bottom absorbent layer 28 thereby retains any fluid discharge run-off from top absorbent layer 20 and serves as a reservoir thereto. This configuration prevents leakage of fluid discharge from absorbent article 10 and a fluid retention ratio of top absorbent layer 20 to bottom absorbent layer 28 of 3:1. This design of absorbent article 10 can retain more than 35 grams of fluid discharge, have an absorbency rate lower than 3 seconds, and rewet values of less than 0.5 g. Other methods of use are also contemplated.

The following exemplary test results of absorbent article 10 provide performance data for illustrative embodiments thereof, as shown in the following tables I-XI. Fluid retention testing was performed on alternate embodiments, which include ten (10) samples of absorbent article 10 having various dry specimen weights (in grams), to illustrate its improved performance. Alternative methods of testing are disclosed. The following specifications of the components of absorbent article 10 and performance data demonstrate the resulting fluid retention ratio of absorbent composite 26 of top absorbent layer 20 to absorbent 34 of bottom absorbent layer 28 as greater than 1:1, and in the desirable range of approximately 3:1.

The formulae employed to calculate the results of fluid retention testing of absorbent article 10 include the following:

Wet specimen weight (g)−Dry specimen weight (g)=Fluid Retention Capacity (g)

Saline %=Fluid Retention Capacity (g)/10(g)

Fluid Retention %=Capacity (g)/Dry specimen weight (g)

Absorbency Factor=Total Capacity (g)/Specimen dry weight (g)

Final Filter Paper Weight (g)−Initial Filter Paper Weight (g)=Rewet (g)

Average readings of 5, 10, 20, etc. samples and record in grams and %

### Total Capacity

The total capacity is the total fluid capacity within a specified length of time needed for complete saturation. Initial dry weights of absorbent article 10 are taken. The method involves submerging absorbent article 10, poly side down, at a 45-degree angle into a 1% saline solution water bath for 30 seconds. Products containing super absorbent polymers must submerge for 3 minutes. Remove absorbent article 10 from the bath and hang freely in a vertical position for 2 minutes without shaking or squeezing the pad. Record the weight of the wet absorbent article 10.

### Absorbency Rate Test

The absorbency rate is determined by how fast at which 1% saline is absorbed in absorbent article 10. With absorbent article 10 laying wrinkle free, poly side down, on a smooth surface, place a cylinder block in the center of absorbent article 10. The cylinder block is a 4″×4″ (0.04 psi) Lucite cylinder block with a 1″ diameter opening in the center. Pour 10 ml of a 1% dyed saline solution from a graduated cylinder onto absorbent article 10 through the Lucite cylinder block opening and immediately start a stopwatch. Allow the solution to flow onto the specimen surface. Stop the stopwatch as soon as the solution is completely absorbed into absorbent article 10. Record the absorption time to the nearest 0.1 sec.

### Rewet

The rewet test determines the amount of fluid released under externally applied pressure. The extent to which absorbent article 10 “feels” dry during use is dependent on its ability to hold fluids under pressure. One measure of dryness in use can be made by determining the amount of fluid returning to a top surface of absorbent article 10 under an applied constant weight.

With absorbent article 10 laying wrinkle free, poly side down, on a smooth surface, place a cylinder block in the center of absorbent article 10. The cylinder block is a 4″×4″ (0.04 psi) Lucite cylinder block with a 1″ diameter opening in the center. Pour 10 ml of a 1% dyed saline solution from a graduated cylinder onto absorbent article 10 through the Lucite cylinder block opening. Allow the solution to be completely absorbed into absorbent article 10. Remove the cylinder block and allow absorbent article 10 to stand for 5 minutes. Weigh and record 10 pieces of VWR Filter Paper Grade #417, 9 cm diameter. After 5 minutes, place the filter paper, a clear Lucite plate, and a 2.2-kilogram weight (0.5 psi) on the center of absorbent article 10. Remove the weight and plate and weigh the filter papers after 15 seconds. The clear Lucite plate should weigh 0.05 kg with dimensions at 4″×4″×⅛″ square.

### Fluid Retention Test

The fluid retention test measures the amount of fluid retained within different zones of absorbent article 10. The test is performed on twenty different samples, which are separated into ten different numbered pairs of comparably weighted products. One pad of each pair should be designated as the “dry pad”, while the other product in the pair should be designated as the “wet pad”. Divide the core length into five equal zones—Front (1), Front Center (2), Center (3), Back Center (4), Back (5)—for each of the samples. Cut the zoned areas for each of the “dry pads”, then separate and weigh each core piece of material, making sure that each piece of material is separated from any other materials while still in tact. Place the “wet pads” onto a sturdy surface, poly side down. Place the 4″×4″ (0.04 psi) Lucite cylinder block with a 1″ diameter opening at the center of Zone 3 and pour 10 ml of a 1% dyed saline solution into the plate. Remove the plate after all of the solution has been absorbed into absorbent article 10. After ten minutes, cut the zoned areas for each of the “wet pads”, then separate and weigh each core piece of material, making sure that each piece of material is separated from any other materials while still in tact.

TABLES I-X shown below, compile results of fluid retention testing performed with absorbent article 10 to determine where the flow of saline comes to rest after ten (10) minutes in various embodiments thereof. The method employed to perform fluid retention testing for samples 1-10 of absorbent article 10 included dividing each of absorbent composite 26 of top absorbent layer 20 and absorbent 34 of bottom absorbent layer 28 into five zones, namely, Front, Front-Center, Center, Back-Center and Back, along the longitudinal length of absorbent article 10.

Each of samples 1-10 were weighed, as well as their separate sections, in a dry state. Absorbent article 10 was insulted with 10 milliliters of dyed 1% saline solution. This was poured into the center of a sectioned, uncut sample of absorbent article 10. The samples rested for 10 minutes. Each of the separate zones of absorbent composite 26 and absorbent 34 was cut and weighed. The dry weight results were subtracted from the wet weight results to determine the amount of saline in each section. The dry weight of the samples was measured without overwrap pouches and the release paper was allowed to remain with the sample.

TABLE I illustrates fluid retention, in accordance with the testing of sample embodiments (1-10) of absorbent article 10 described herein, of a FRONT zone of absorbent composite 26.

TABLE I
Absorbent composite 26
ZONE: FRONT

| | Dry | | | | |
|---|---|---|---|---|---|
| Sample | Weight | Wet Weight | Capacity | Saline % | Fluid Ret % |
| 1 | 0.32 | 0.67 | 0.35 | 3.50% | 109.38% |
| 2 | 0.31 | 0.89 | 0.58 | 5.80% | 187.10% |
| 3 | 0.32 | 0.84 | 0.52 | 5.20% | 162.50% |
| 4 | 0.32 | 0.55 | 0.23 | 2.30% | 71.88% |
| 5 | 0.32 | 0.93 | 0.61 | 6.10% | 190.63% |
| 6 | 0.34 | 1.01 | 0.67 | 6.70% | 197.06% |
| 7 | 0.34 | 0.82 | 0.48 | 4.80% | 141.18% |
| 8 | 0.31 | 0.7 | 0.39 | 3.90% | 125.81% |
| 9 | 0.32 | 0.58 | 0.26 | 2.60% | 81.25% |
| 10 | 0.3 | 0.76 | 0.46 | 4.60% | 153.33% |
| Average: | 0.32 | 0.775 | 0.455 | 4.55% | 142.01% |

TABLE II illustrates fluid retention, in accordance with the testing of sample embodiments (1-10) of absorbent article 10 described herein, of a FRONT-CENTER zone of absorbent composite 26.

TABLE II
Absorbent composite 26
ZONE: FRONT-CENTER

| | Dry | | | | |
|---|---|---|---|---|---|
| Sample | Weight | Wet Weight | Capacity | Saline % | Fluid Ret % |
| 1 | 0.36 | 2.39 | 2.03 | 20.30% | 563.89% |
| 2 | 0.34 | 2.42 | 2.08 | 20.80% | 611.76% |
| 3 | 0.36 | 2.39 | 2.03 | 2030% | 563.89% |
| 4 | 0.36 | 2.26 | 1.9 | 19.00% | 527.78% |
| 5 | 0.34 | 2.33 | 1.99 | 19.90% | 585.29% |
| 6 | 0.38 | 2.39 | 2.01 | 20.10% | 528.95% |
| 7 | 0.36 | 2.39 | 2.03 | 20.30% | 563.89% |
| 8 | 0.4 | 2.35 | 1.95 | 19.50% | 487.50% |
| 9 | 0.35 | 2.31 | 1.96 | 19.60% | 560.00% |
| 10 | 0.3 | 2.23 | 1.93 | 19.30% | 643.33% |
| Average: | 0.355 | 2.346 | 1.991 | 19.91% | 563.63% |

TABLE III illustrates fluid retention, in accordance with the testing of sample embodiments (1-10) of absorbent article 10 described herein, of a CENTER zone of absorbent composite 26.

TABLE III
Absorbent composite 26
ZONE: CENTER

| | Dry | | | | |
|---|---|---|---|---|---|
| Sample | Weight | Wet Weight | Capacity | Saline % | Fluid Ret % |
| 1 | 0.33 | 2.53 | 2.2 | 22.00% | 666.67% |
| 2 | 0.33 | 2.65 | 2.32 | 23.20% | 703.03% |
| 3 | 0.35 | 2.38 | 2.03 | 20.30% | 580.00% |
| 4 | 0.35 | 2.49 | 2.14 | 21.40% | 611.43% |
| 5 | 0.34 | 2.24 | 1.9 | 19.00% | 558.82% |
| 6 | 0.37 | 2.57 | 2.2 | 22.00% | 594.59% |
| 7 | 0.34 | 2.53 | 2.19 | 21.90% | 644.12% |
| 8 | 0.38 | 2.52 | 2.14 | 21.40% | 563.16% |
| 9 | 0.33 | 2.54 | 2.21 | 22.10% | 669.70% |
| 10 | 0.34 | 2.47 | 2.13 | 21.30% | 626.47% |
| Average: | 0.346 | 2.492 | 2.146 | 21.46% | 621.80% |

TABLE IV illustrates fluid retention, in accordance with the testing of sample embodiments (1-10) of absorbent article 10 described herein, of a BACK-CENTER zone of absorbent composite 26.

TABLE IV
Absorbent composite 26
ZONE: BACK-CENTER

| | Dry | | | | |
|---|---|---|---|---|---|
| Sample | Weight | Wet Weight | Capacity | Saline % | Fluid Ret % |
| 1 | 0.34 | 2.24 | 1.9 | 19.00% | 558.82% |
| 2 | 0.33 | 2.32 | 1.99 | 19.90% | 603.03% |
| 3 | 0.37 | 2.26 | 1.89 | 18.90% | 510.81% |
| 4 | 0.35 | 2.48 | 2.13 | 21.30% | 608.57% |
| 5 | 0.34 | 2.23 | 1.89 | 18.90% | 555.88% |
| 6 | 0.37 | 2.21 | 1.84 | 18.40% | 497.30% |
| 7 | 0.34 | 2.4 | 2.06 | 20.60% | 606.88% |
| 8 | 0.37 | 2.41 | 2.04 | 20.40% | 551.35% |
| 9 | 0.35 | 2.38 | 2.03 | 20.30% | 580.00% |
| 10 | 0.36 | 2.47 | 2.11 | 0.211 | 586.11% |
| Average: | 0.352 | 2.34 | 1.988 | 19.88% | 565.78% |

TABLE V illustrates fluid retention, in accordance with the testing of sample embodiments (1-10) of absorbent article 10 described herein, of a BACK zone of absorbent composite 26.

TABLE V
Absorbent composite 26
ZONE: BACK

| | Dry | | | | |
|---|---|---|---|---|---|
| Sample | Weight | Wet Weight | Capacity | Saline % | Fluid Ret % |
| 1 | 0.33 | 0.72 | 0.39 | 3.90% | 118.18% |
| 2 | 0.32 | 0.57 | 0.25 | 2.50% | 78.13% |
| 3 | 0.35 | 0.84 | 0.49 | 4.90% | 140.00% |
| 4 | 0.36 | 1.06 | 0.7 | 7.00% | 194.44% |
| 5 | 0.31 | 0.63 | 0.32 | 3.20% | 103.23% |
| 6 | 0.33 | 0.63 | 0.3 | 3.00% | 90.91% |
| 7 | 0.31 | 0.78 | 0.47 | 4.70% | 151.61% |
| 8 | 0.34 | 0.75 | 0.41 | 4.10% | 120.59% |
| 9 | 0.34 | 0.89 | 0.55 | 5.50% | 161.76% |
| 10 | 0.33 | 1.03 | 0.7 | 7.00% | 212.12% |
| Average: | 0.332 | 0.79 | 0.458 | 4.58% | 137.10% |

TABLE VI illustrates fluid retention, in accordance with the testing of sample embodiments (1-10) of absorbent article 10 described herein, of a FRONT zone of absorbent 34.

TABLE VI
Absorbent 34
ZONE: FRONT

| | Dry | | | | |
|---|---|---|---|---|---|
| Sample | Weight | Wet Weight | Capacity | Saline % | Fluid Ret % |
| 1 | 0.25 | 0.25 | 0 | 0.00% | 0.00% |
| 2 | 0.25 | 0.32 | 0.07 | 0.70% | 28.00% |
| 3 | 0.24 | 0.33 | 0.09 | 0.90% | 37.50% |
| 4 | 0.24 | 0.34 | 0.1 | 1.00% | 41.67% |
| 5 | 0.24 | 0.25 | 0.01 | 0.10% | 4.17% |
| 6 | 0.29 | 0.34 | 0.05 | 0.50% | 17.24% |
| 7 | 0.23 | 0.24 | 0.01 | 0.10% | 4.35% |
| 8 | 0.26 | 0.28 | 0.02 | 0.20% | 7.69% |
| 9 | 0.26 | 0.27 | 0.01 | 0.10% | 3.85% |
| 10 | 0.28 | 0.28 | 0 | 0.00% | 0.00% |
| Average: | 0.254 | 0.29 | 0.036 | 0.36% | 14.45% |

TABLE VII illustrates fluid retention, in accordance with the testing of sample embodiments (1-10) of absorbent article 10 described herein, of a FRONT-CENTER zone of absorbent 34.

TABLE VII
Absorbent 34
ZONE: FRONT-CENTER

| | Dry | | | | |
|---|---|---|---|---|---|
| Sample | Weight | Wet Weight | Capacity | Saline % | Fluid Ret % |
| 1 | 0.25 | 0.87 | 0.62 | 6.20% | 248.00% |
| 2 | 0.31 | 0.84 | 0.53 | 5.30% | 170.97% |
| 3 | 0.27 | 0.79 | 0.52 | 5.20% | 192.59% |
| 4 | 0.25 | 0.78 | 0.53 | 5.30% | 212.00% |
| 5 | 0.26 | 1.1 | 0.84 | 8.40% | 323.08% |
| 6 | 0.28 | 0.88 | 0.6 | 6.00% | 214.29% |
| 7 | 0.28 | 0.83 | 0.55 | 5.50% | 196.43% |
| 8 | 0.28 | 0.86 | 0.58 | 5.80% | 207.14% |
| 9 | 0.31 | 0.8 | 0.49 | 4.90% | 158.06% |
| 10 | 0.32 | 0.69 | 0.37 | 3.70% | 115.63% |
| Average: | 0.281 | 0.844 | 0.563 | 5.63% | 203.82% |

TABLE VIII illustrates fluid retention, in accordance with the testing of sample embodiments (1-10) of absorbent article 10 described herein, of a CENTER zone of absorbent 34.

TABLE VIII
Absorbent 34
ZONE: CENTER

| | Dry | | | | |
|---|---|---|---|---|---|
| Sample | Weight | Wet Weight | Capacity | Saline % | Fluid Ret % |
| 1 | 0.23 | 1.6 | 1.37 | 13.70% | 595.65% |
| 2 | 0.3 | 1.74 | 1.44 | 14.40% | 480.00% |
| 3 | 0.27 | 1.37 | 1.1 | 11.00% | 407.41% |
| 4 | 0.27 | 1.39 | 1.12 | 11.20% | 414.81% |
| 5 | 0.26 | 1.82 | 1.56 | 15.60% | 600.00% |
| 6 | 0.29 | 1.58 | 1.29 | 12.90% | 444.83% |
| 7 | 0.28 | 1.33 | 1.05 | 10.50% | 375.00% |
| 8 | 0.28 | 1.4 | 1.12 | 11.20% | 400.00% |
| 9 | 0.3 | 1.35 | 1.05 | 10.50% | 350.00% |
| 10 | 0.32 | 1.39 | 1.07 | 10.70% | 334.38% |
| Average: | 0.28 | 1.497 | 1.217 | 12.17% | 440.21% |

TABLE IX illustrates fluid retention, in accordance with the testing of sample embodiments (1-10) of absorbent article 10 described herein, of a BACK-CENTER zone of absorbent 34.

TABLE IX
Absorbent 34
ZONE: BACK-CENTER

| | Dry | | | | |
|---|---|---|---|---|---|
| Sample | Weight | Wet Weight | Capacity | Saline % | Fluid Ret % |
| 1 | 0.27 | 0.8 | 0.53 | 5.30% | 196.30% |
| 2 | 0.27 | 0.76 | 0.49 | 4.90% | 181.48% |
| 3 | 0.29 | 0.79 | 0.5 | 5.00% | 172.41% |
| 4 | 0.27 | 0.91 | 0.64 | 6.40% | 237.04% |
| 5 | 0.26 | 0.73 | 0.47 | 4.70% | 180.77% |
| 6 | 0.35 | 0.76 | 0.41 | 4.10% | 117.14% |
| 7 | 0.29 | 0.76 | 0.47 | 4.70% | 162.07% |
| 8 | 0.25 | 0.7 | 0.45 | 4.50% | 180.00% |
| 9 | 0.33 | 0.73 | 0.4 | 4.00% | 121.21% |
| 10 | 0.33 | 0.68 | 0.35 | 3.50% | 106.06% |
| Average: | 0.291 | 0.762 | 0.471 | 4.71% | 165.45% |

TABLE X illustrates fluid retention, in accordance with the testing of sample embodiments (1-10) of absorbent article 10 described herein, of a BACK zone of absorbent 34.

TABLE X
Absorbent 34
ZONE: BACK

| | Dry | | | | |
|---|---|---|---|---|---|
| Sample | Weight | Wet Weight | Capacity | Saline % | Fluid Ret % |
| 1 | 0.22 | 0.31 | 0.09 | 0.90% | 40.91% |
| 2 | 0.25 | 0.26 | 0.01 | 0.10% | 4.00% |
| 3 | 0.26 | 0.29 | 0.03 | 0.30% | 11.54% |
| 4 | 0.25 | 0.28 | 0.03 | 0.30% | 12.00% |
| 5 | 0.22 | 0.23 | 0.01 | 0.10% | 4.55% |
| 6 | 0.29 | 0.32 | 0.03 | 0.30% | 10.34% |
| 7 | 0.26 | 0.27 | 0.01 | 0.10% | 3.85% |
| 8 | 0.26 | 0.27 | 0.01 | 0.10% | 3.85% |
| 9 | 0.26 | 0.28 | 0.02 | 0.20% | 7.69% |
| 10 | 0.29 | 0.3 | 0.01 | 0.10% | 3.45% |
| Average: | 0.256 | 0.281 | 0.025 | 0.25% | 10.22% |

It was found that the distribution of fluid between absorbent composite 26 including SAP/airlaid material and absorbent 34 including airlaid material had a fluid retention ratio of greater than 1:1, and in particular embodiments approximately 3:1. The Front and Back zones of absorbent article 10 had about 8% of the saline after ten minutes of rest. The Front Center and Back Center zones of absorbent article 10 had less than 40% of the saline after ten minutes of rest. The Center zone of absorbent article 10 had about 20% of the saline after ten minutes of rest.

TABLE XI shown below, compiles the fluid retention results of the above fluid retention testing performed with various embodiments of absorbent article 10.

TABLE XI
Absorbent Article 10

| | ZONE: | | | | | Total Fluid | |
|---|---|---|---|---|---|---|---|
| | | FRONT- | | BACK- | | Consumption | Total Fluid |
| | FRONT | CENTER | CENTER | CENTER | BACK | per volume | Retention |
| Absorbent | | | | | | | |
| composite 26 | | | | | | | |
| Fluid | 142.01% | 563.63% | 621.80% | 565.78% | 137.10% | 75.26% | 2031.00% |
| Retention % | | | | | | | |
| Absorbent 34 | | | | | | | |
| Fluid | 14.45% | 203.82% | 440.21% | 165.45% | 10.22% | 24.74% | 833.45% |
| Retention % | | | | | | | |

TABLES XII and XIII shown below, compile results of fluid retention testing performed with various embodiments of absorbent article 10 to determine absorbency rates, rewet values and total fluid retention capacity, in accordance with the testing of absorbent article 10 described herein. Fluid retention testing was performed on alternate embodiments, which include samples of absorbent article 10 having various basis weights for absorbent composite 26 and absorbent 34 (in grams per square meter), to illustrate its improved performance. The basis weight of acquisition film layer 18 was constant at 36.6 gsm. Acquisition film layer 18 has a width of 40 mm, top absorbent layer 20 has a width of 50 mm and bottom absorbent layer 28 has a width of 65 mm.

TABLE XII

| | | | | | |
|---|---|---|---|---|---|
| Basis Weight | 36.6 gsm | 36.6 gsm | 36.6 gsm | 36.6 gsm | 36.6 gsm |
| Layer 18 | | | | | |
| Absorbent | 170 gsm | 170 gsm | 125 gsm | 150 gsm | 170 gsm |
| Composite | | | | | |
| 26 | | | | | |
| Absorbent | 100 gsm | 130 gsm | 135 gsm | 135 gsm | 135 gsm |
| 34 | | | | | |
| AbsRate: sec | 1.84 | 1.9 | 1.63 | 1.59 | 1.41 |
| Rewet: g | 0.19 | 0.18 | 0.55 | 0.33 | 0.26 |
| Leakage y/n | None | None | None | None | None |
| DryWeight: | 4.72 | 5.06 | 4.43 | 4.84 | 5.06 |
| g | | | | | |
| WetWeight: | 43.91 | 49.52 | 39.12 | 45.48 | 49.66 |
| g | | | | | |
| TotCapacity: | 39.19 | 44.46 | 34.69 | 40.64 | 44.6 |
| g | | | | | |

TABLE XIII

| Basis Weight | 36.6 gsm | 36.6 gsm | 36.6 gsm | 36.6 gsm | 36.6 gsm | 36.6 gsm | 36.6 gsm |
|---|---|---|---|---|---|---|---|
| Layer 18 | | | | | | | |
| Absorbent | 125 gsm | 150 gsm | 170 gsm | 150 gsm | 170 gsm | 150 gsm | 170 gsm |
| Composite 26 | | | | | | | |
| Absorbent 34 | 140 gsm | 140 gsm | 140 gsm | 150 gsm | 150 gsm | 180 gsm | 180 gsm |
| AbsRate: sec | 1.72 | 1.5 | 1.52 | 1.53 | 1.44 | 1.59 | 1.5 |
| Rewet: g | 0.24 | 0.1 | 0.07 | 0.29 | 0.38 | 0.08 | 0.07 |
| Leakage: y/n | None | None | None | None | None | None | None |
| DryWeight: g | 4.73 | 5.13 | 5.28 | 5.03 | 5.45 | 5.58 | 5.76 |
| WetWeight: g | 41.49 | 43.23 | 47.18 | 43.48 | 49.88 | 48.58 | 50.91 |
| TotCapacity: g | 36.76 | 38.1 | 41.9 | 38.45 | 44.43 | 43 | 45.15 |

It was found that the configuration of absorbent article 10 resulted in improved performance including for example, fluid retention capacities of 34.0-46.0 grams, absorbency rates of less than 3.0 seconds and rewet values under 0.5 grams.

It will be understood that various modifications may be made to the embodiments disclosed herein. Therefore, the above description should not be construed as limiting, but merely as exemplification of the various embodiments. Those skilled in the art will envision other modification within the scope and spirit of the claims appended hereto.

What is claimed is:

1. An absorbent article comprising:
a fluid permeable top sheet;
a transfer layer disposed adjacent the top sheet;
a first layer having a garment facing surface and a body facing surface disposed adjacent the transfer layer, the first layer including an absorbent composite having a first density;
a second layer disposed adjacent the garment facing surface of the first layer and including an absorbent having a second density, wherein the first density is greater than the second density such that a ratio of fluid retained by the first layer relative to fluid retained by the second layer is greater than 1.0; and
a fluid impermeable back sheet disposed adjacent to the second layer.

2. An absorbent article as recited in claim 1, wherein the ratio is approximately 3.0.

3. An absorbent article as recited in claim 1, wherein the transfer layer includes a three dimensional apertured film.

4. An absorbent article as recited in claim 1, wherein the transfer layer includes a material having a basis weight of at least 35 grams per square meter.

5. An absorbent article as recited in claim 1, wherein the absorbent composite of the first layer includes an airlaid material and a super absorbent polymer material.

6. An absorbent article as recited in claim 1, wherein the absorbent composite of the first layer has a basis weight ranging from approximately 150 grams per square meter to 170 grams per square meter.

7. An absorbent article as recited in claim 1, wherein the absorbent of the second layer includes an airlaid material.

8. An absorbent article as recited in claim 1, wherein the absorbent of the second layer has a basis weight ranging from approximately 140 grams per square meter to 200 grams per square meter.

9. An absorbent article as recited in claim 1, wherein the first layer and the second layer each define a longitudinal length and a width, the width of the second layer being equal to or greater than the width of the first layer.

10. An absorbent article as recited in claim 1, wherein the absorbent article has a dry weight of less than approximately 5.20 grams and a fluid capacity of greater than or equal to 35.0 grams.

11. An absorbent article comprising:
a fluid permeable top sheet;
a transfer layer disposed adjacent the top sheet;
a first layer having a garment facing surface and a body facing surface, the body facing surface disposed for engagement with the transfer layer and in fluid communication therewith, the first layer including an absorbent composite having a first density and a basis weight ranging from approximately 150 grams per square meter to 170 grams per square meter;
a second layer having a garment facing surface and a body facing surface, the body facing surface of the second layer disposed for engagement with the garment facing surface of the first layer and in fluid communication therewith, the second layer including an absorbent having a second density and a basis weight ranging from approximately 130 grams per square meter to 150 grams per square meter, wherein the first density is greater than the second density; and
a fluid impermeable backsheet disposed adjacent to the garment facing surface of the second layer.

12. An absorbent article as recited in claim 11, wherein the first density is greater than the second density such that a ratio of fluid retained by the first layer relative to fluid retained by the second layer is greater than 1.0.

13. An absorbent article as recited in claim 12, wherein the ratio is approximately 3.0.

14. An absorbent article as recited in claim 11, wherein the transfer layer includes a three dimensional apertured film.

15. An absorbent article as recited in claim 11, wherein the layer includes a material having a basis weight of at least 35 grams per square meter.

16. An absorbent article as recited in claim 11, wherein the absorbent composite of the first layer includes an airlaid material and a super absorbent polymer material.

17. An absorbent article as recited in claim 11, wherein the absorbent of the second layer includes an airlaid material.

18. An absorbent article as recited in claim 11, wherein the first layer and the second layer each define a longitudinal length and a width, the width of the second layer being greater than the width of the first layer.

19. An absorbent article as recited in claim 11, wherein the absorbent article has a dry weight of less than approximately 5.20 grams and a fluid capacity of greater than or equal to 35.0 grams.

20. An absorbent article comprising:
a fluid permeable top sheet;
a transfer layer disposed adjacent the top sheet;
a first layer defining a longitudinal length, a garment facing surface and a body facing surface that engages the transfer layer, wherein the first layer includes an absorbent composite having a first density and a basis weight of approximately 150 grams per square meter;
a second layer defining a longitudinal length, a garment facing surface and a body facing surface that engages the garment facing surface of the first layer, wherein the second layer includes an absorbent having a second density and a basis weight of approximately 140 grams per square meter, the second layer extending a width greater than a width of the first layer,
wherein the first density is greater than the second density such that a ratio of fluid retained by the first layer relative to fluid retained by the second layer is approximately 3.0; and
a fluid impermeable backsheet disposed adjacent to the garment facing surface of the second layer.

21. An absorbent article comprising:
a fluid permeable top sheet;
a transfer layer disposed adjacent the top sheet;
a first layer having a garment facing surface and a body facing surface disposed adjacent the transfer layer, the first layer including an absorbent composite having a first density; the absorbent composite defining a plurality of absorbency zones including a front, front-center, center, back-center and back;
a second layer disposed adjacent the garment facing surface of the first layer and including an absorbent having a second density, the absorbent defining a plurality of absorbency zones, including a front, front-center, center, back-center and back, wherein the first density is greater than the second density such that a ratio of fluid retained by the first layer relative to fluid retained by the second layer is greater than 1.0; and
a fluid impermeable back sheet disposed adjacent to the second layer.

22. An absorbent article as recited in claim 21, wherein the front zone of the absorbent composite has an average fluid retention percentage of greater than 117 and the front zone of the absorbent has an average fluid retention percentage of less than 3.

23. An absorbent article as recited in claim 21, wherein the front zone of the absorbent composite has an average fluid retention percentage of approximately 142 and the front zone of the absorbent has an average fluid retention percentage of 14.

24. An absorbent article as recited in claim 21, wherein the front-center zone of the absorbent composite has an average fluid retention percentage of greater than 308 and the front-center zone of the absorbent has an average fluid retention percentage of less than 200.

25. An absorbent article as recited in claim 21, wherein the front-center zone of the absorbent composite has an average fluid retention percentage of approximately 564 and the front-center zone of the absorbent has an average fluid retention percentage of 204.

26. An absorbent article as recited in claim 21, wherein the center zone of the absorbent composite has an average fluid retention percentage of greater than 421 and the center zone of the absorbent has an average fluid retention percentage of less than 747.

27. An absorbent article as recited in claim 21, wherein the center zone of the absorbent composite has an average fluid retention percentage of approximately 622 and the center zone of the absorbent has an average fluid retention percentage of approximately 440.

28. An absorbent article as recited in claim 21, wherein the back-center zone of the absorbent composite has an average fluid retention percentage of greater than 318 and the back-center zone of the absorbent has an average fluid retention percentage of less than 220.

29. An absorbent article as recited in claim 21, wherein the back-center zone of the absorbent composite has an average fluid retention percentage of approximately 566 and the back-center zone of the absorbent has an average fluid retention percentage of approximately 165.

30. An absorbent article as recited in claim 21, wherein the back zone of the absorbent composite has an average fluid retention percentage of greater than 162 and the back-center zone of the absorbent has an average fluid retention percentage of less than 7.

31. An absorbent article as recited in claim 21, wherein the back zone of the absorbent composite has an average fluid retention percentage of approximately 137 and the back zone of the absorbent has an average fluid retention percentage of approximately 10.

32. An absorbent article as recited in claim 21, wherein the absorbent composite has a total average fluid retention percentage of greater than 1326 and the absorbent has a total average fluid retention percentage of less than 1177.

33. An absorbent article comprising:
a fluid permeable top sheet;
a transfer layer disposed adjacent the top sheet;
a first layer having a garment facing surface and a body facing surface, the body facing surface disposed for engagement with the transfer layer and in fluid communication therewith, the first layer including an absorbent composite having a first density;
a second layer having a garment facing surface and a body facing surface, the body facing surface of the second layer disposed for engagement with the garment facing surface of the first layer and in fluid communication therewith, the second layer including an absorbent having a second density, wherein the first density is greater than the second density; and
a fluid impermeable backsheet disposed adjacent to the garment facing surface of the second layer, wherein the absorbent article has a dry weight of less than 6.0 grams and a rewet value of less than 0.6.

34. An absorbent article as recited in claim 33, wherein the absorbent article has an absorbency rate of less than 2.0 seconds.

35. An absorbent article as recited in claim 33, wherein the rewet value of less than 0.2.
